(19) United States
(12) Patent Application Publication
(10) Pub. No.: US 2004/0172330 A1
(43) Pub. Date: Sep. 2, 2004

(54) Business method and apparatus for advertising and fundraising

(76) Inventor: J. Edward Gibson, Springfield, MO (US)

Correspondence Address: HUSCH & EPPENBERGER, LLC, 190 CARONDELET PLAZA, SUITE 600, ST. LOUIS, MO, 63105-3441, US

(21) Appl. No.: 10/772,878

(22) Filed: Feb. 5, 2004

Related U.S. Application Data
(60) Provisional application No. 60/445,596, filed on Feb. 6, 2003.

(51) Int. Cl. G06F 17/60

(52) U.S. Cl. 705/14

(57) ABSTRACT

A business method for advertising and fundraising and its associated device are disclosed. The business method provides for fundraising without sales and without money outlays from fundraising organizations. Hosting sponsors pay for apparatuses used during the fundraising event in exchange for advertisement on the apparatuses. The business method also increases pedestrian traffic into each hosting sponsor's location.

### CROSS-REFERENCE TO RELATED APPLICATIONS

This application claims priority from U.S. Provisional Patent Application No. 60/445,696 filed Feb. 6, 2003.

### TECHNICAL FIELD OF THE INVENTION

The present invention relates to advertising and fundraising and, more specifically, a business method for advertising and fundraising to collect money and an advertising and fundraising apparatus for collecting money.

### DESCRIPTION OF THE RELATED ART

Various organizations find it necessary to have fundraising events to offset certain costs and expenses and to finance special events. For example, educational institutions routinely ask students to sell candy, books, coupon books, popcorn, candles, donuts or other items for profit. Educational institutions purchase these items at a reduced price and sell them at a marked-up price. The educational institutions retain the proceeds from the sale. The disadvantages of this fundraising method is that it requires out-of-pocket money and money advances from the educational institutions and only a portion of the collected amounts are retained by the educational institutions. Another disadvantage is the destruction of unsold items and the losses incurred on unsold inventory. Yet another disadvantage is the amount of extra work created for children and parents from which the school gains only marginal profit. A significant disadvantage is the risk created when children perform door-to-door solicitations.

In a first example of a known fundraising event, there is a method of selling catalog products, such as candles, for a school fundraiser. In the method, a fundraising company contacts a school representative to offer a fundraising program. The school representative agrees to the fundraising program.

Thereafter, the fundraising company sends promotional materials and product catalogs to the school representative. Then the school representative and/or the fundraising company hold an informational meeting for students and volunteers. Often, the fundraising company promises prizes in an effort to motivate the students.

While the fundraising program may be designed for students, in reality students place, or attempt to place, much of the burden of the fundraising program on parents. Parents respond to this pressure in one of three ways. First, a parent may refuse to assist the student and require the student to either sell the product on their own or abandon the program. Second, a parent may assist the student with product sales, which results in a greater stress level for the parent and less time for other activities. Third, a parent may relieve the student of any sales responsibility, such as by taking the product catalog to the parent's workplace. This last category is often detrimental to the student and parent. Here, the student loses a character building opportunity and the parent may contribute to a negative workplace environment. For example, the parent's coworkers may feel an obligation to buy an unwanted and unused poorly manufactured product out of peer pressure. This may result in feelings of resentment toward the parent.

After the students and/or parents have sold the products from the catalogs, the sales orders taken to the school representative who passes them along to the fundraising company. Thereafter, the fundraising company sends the ordered products to the school representative. The school representative must spend a considerable amount of time organizing and distributing the ordered products to the students.

Once the products are distributed to the students, each student must somehow transport the ordered products home and then to the customer. First, a parent may make a special trip to pick up the student and ordered products at the school. This often causes inconvenience for the parent. Second, the student may attempt to carry the ordered products, along with their text books and homework assignments, on the school bus. The ordered product is much more likely to get lost, damaged, or stolen on the school bus, and this usually results in financial liability for the school or the parent.

Thereafter, the student must distribute the ordered product. This results in telephone calls to customers, car trips to customers, and other time consuming activities. Oftentimes, a customer is not prepared to pay at the time of delivery, which results in additional telephone calls and car trips.

After all of the products have been delivered and the school representative spends a considerable amount of time tracking orders and counting funds received, the school representative calculates the amount due the fundraising company. Usually the school must split the amount raised with the fundraising company. Splitting the funds raised diluted the efforts of all who invested in the fundraising program.

The above example lacks numerous efficiencies. First, the catalog products are often sold at inflated prices. Second, the catalog product is often an unwanted product that would not be purchased by the average consumer but for the fact that the product is associated with a fundraising program. Third, much effort of students, parents, volunteers, and school representatives is wasted in conducting the fundraiser for only a portion of the funds raised.

In another example, there is known a method of event-based fundraising. In the method, volunteers decide to hold a fundraising event, such as a “fun” fair. Thereafter, the volunteers spend a considerable amount of time organizing the “fun” fair. For example, the volunteers must make decisions on games, prizes, and products to sell. Then the volunteers must recruit others to sponsor, staff, develop or otherwise assist in preparing the “fun” fair. Hundreds of volunteer hours are usually required for an event-based fundraiser.

Once the fundraiser is organized, the event-based fundraiser is held. Oftentimes, an admission fee is charged for entry to the fundraiser. “Fun” fair attendees play games, compete for prizes, and purchase products, such as comestibles.

Event-based fundraisers also have numerous inefficiencies. First, there is great risk that the fundraiser will not be successful. In that case, numerous volunteer hours will have been wasted. Second, the event-based fundraiser requires an extraordinary amount of effort from a volunteer staff. Hence, it is difficult to obtain volunteers to assist in holding the fundraiser. Moreover, once the event is held, volunteers may be discouraged and not desire to assist in a subsequent fundraiser.

The present invention is directed to overcoming one or more of the problems set forth above.

### BRIEF SUMMARY OF THE INVENTION

In one aspect of this present invention, a business method for advertising and fundraising is disclosed. The business method provides for a greater return to the fundraising organizations than other types of fundraising events because the sponsors pay for the apparatuses used in fundraising.

In another aspect of this present invention, an apparatus for advertising and fundraising is disclosed. The apparatus serves dual functions; the apparatus is used to collect money during a fundraising event and is used as an advertising medium for the sponsors.

Further features and advantages of the present invention, as well as the structure and operation of various embodiments of the present invention, are described in detail below with reference to the accompanying drawings.

### BRIEF DESCRIPTION OF THE DRAWINGS

For a better understanding of the present invention, reference may be made to the accompanying drawings in which:

FIG. 1a is a perspective view of an apparatus for advertising and fundraising in a first embodiment;

FIG. 1b is a perspective view of the apparatus for advertising and fundraising in a second embodiment;

FIG. 2 illustrates a schematic process diagram of a first business method for advertising and fundraising; and

FIGS. 3a-e illustrate a schematic process diagram of a second business method for advertising and fundraising.

### DETAILED DESCRIPTION OF THE INVENTION

In the following detailed description numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

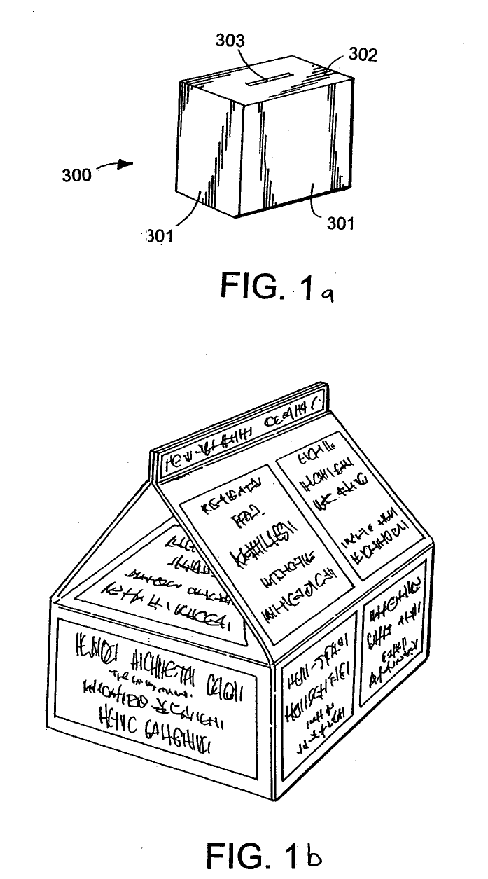

Referring now to the drawings and initially to FIG. 1a, an apparatus for advertising and fundraising to collect money for fundraising organizations is shown generally as numeral 300. The apparatus 300 has a rectangular shape; however, it will be understood by those skilled in the art that the apparatus 300 can have various configurations. In the embodiment depicted in FIG. 1a, the apparatus 300 is made of paperboard, corrugated paper, or other disposable material. The apparatus 300 has advertising sides 301 and an advertising top 302. There is an opening 303 for receiving money from a donor. Money slipped through the opening 303 is temporarily stored in a cavity (not shown) defined by the sides 301, the top 302 and a bottom (not shown). When the apparatus 300 is full of money, the apparatus 300 is opened via a port (not shown) and the money removed. FIG. 1b illustrates a second embodiment wherein the apparatus 300 is in the shape of a school house.

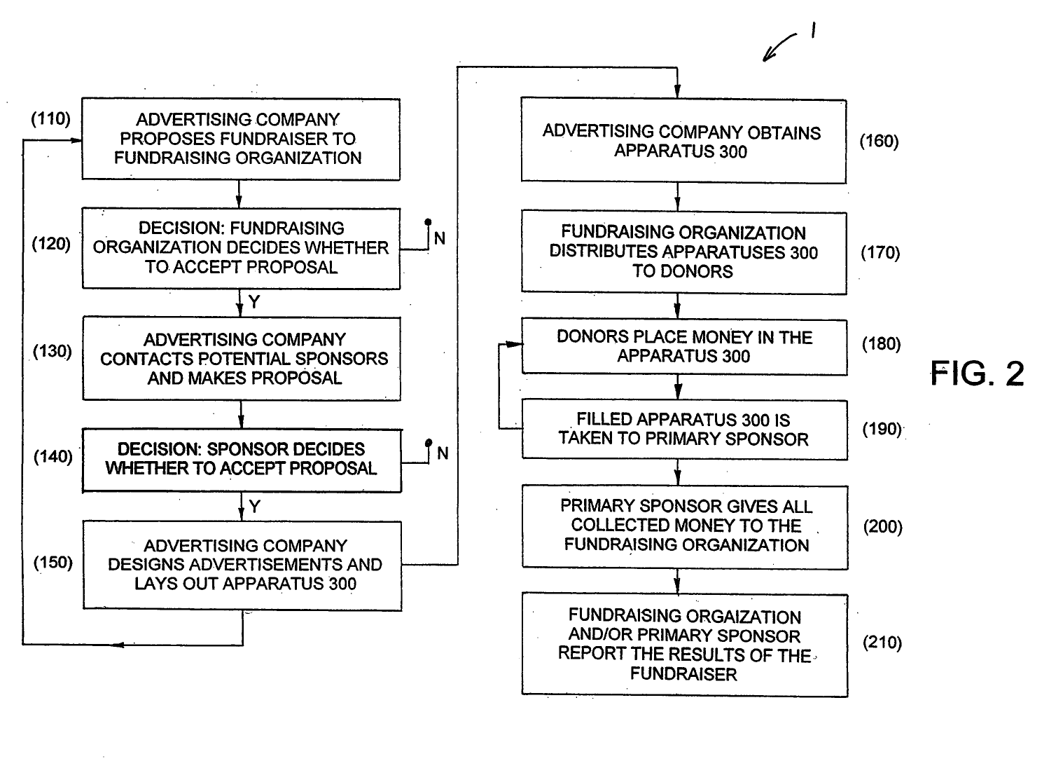

Referring now to FIG. 2, a flowchart of a business method for advertising and fundraising to collect money is illustrated and is denoted generally by reference numeral 1. In the description of the flowchart shown in FIG. 2, the functional explanation marked with numerals in angle brackets, <nnn>, will refer to the flowchart blocks bearing that number.

A fundraising organization is the entity that desires to have a fundraiser to obtain money to offset costs and expenses or to finance special events. A sponsor is an entity that desires to finance materials, such as the apparatus 300, needed for a fundraising event in exchange for an advertisement placed on the apparatus 300 that will be used during the fundraising event. A primary sponsor is a financial institution that agrees to collect money from filled apparatuses 300 for the fundraising organization. A secondary sponsor is any other sponsor. An advertising company interacts with the fund raising organization and the sponsors, wherein the advertising company creates a fundraising program for a fund raising organization and sells advertisements to the sponsors. The advertising company also obtains the apparatus 300 used during the fundraising event and places the advertisements of the sponsor on the apparatus 300.

In a first step <110>, the advertising company contacts the fundraising organization to propose a fundraiser. In the method described in FIG. 2, the fundraising organization is a school, however, those skilled in the art will understand that the fundraising organization may equally be a high school band, a civic group, a fraternity/sorority, etc. The fundraising organization either accepts the proposal or rejects it.

In an alternative first step, the advertising company contacts primary and secondary sponsors instead of fundraising organizations to propose a fundraiser for a specified fundraising organization. If the sponsors accept the proposal, the advertising company then contacts the fundraising organization for cooperation in establishing the fundraiser.

If the fundraising organization accepts the proposal, the fundraising organization enters into an agreement for a fundraiser with the advertising company in a second step <120>. The agreement establishes the relationship between the advertising company and the fundraising organization. The agreement may set out the number of apparatuses 300 required and the goal of the fundraiser. The agreement may also provide for payment, either flat fee or percentage of the amount raised, by the fundraising organization. In some embodiments, the method may additionally include the fundraising organization supplying the advertising company with a list of potential sponsors as part of the agreement. Additionally, the fundraising organization may be required as part of the agreement to return the apparatuses after use. In this manner, the fundraising organization could not reuse the apparatuses for additional fundraisers.

The advertising company contacts potential sponsors in a third step <130>. The advertising company explains the fundraiser to the sponsors and proposes that the sponsor supports the fundraising organization by purchasing advertisements to be placed on the apparatuses 300. In some embodiments, the proposal also includes the sponsors providing support by collecting money from the filled apparatuses 300 and pooling the collected money for the fundraising organizations. Each sponsor either accepts or rejects the proposal.

If the sponsor accepts, the sponsor enters into an agreement with the advertising company and sends relevant advertising information to the advertising company in a fourth step <140>. The agreement establishes the relationship between the advertising company and the sponsor. The advertising information may include, for example, business name, business location, and company slogan. The agreement can include various provisions such as payment for services and quality of advertising controls.

In a fifth step <150>, the advertising company designs advertisements for each sponsor and arranges the advertisements on the apparatus 300. To best ensure visibility of each advertisement, the advertising company may specify a minimum and/or a maximum number of advertisements per each apparatus 300. For example, the advertising company may specify only one advertisement per side of the apparatus 300.

In one embodiment, steps one <110> through five <150> may be repeated for a multitude of schools whereby the advertising company generates revenue by selling advertisements for a school-specific apparatus to several sponsors. Moreover, in this embodiment the advertising company can combine school-specific apparatuses 300 into the same manufacturing run, thereby saving manufacturing costs.

In a sixth step <160>, the advertising company obtains the apparatuses 300 from a printing or packaging company but the advertising company may also manufacture the apparatuses 300 in-house. If a printing or packaging company manufactures the apparatuses 300, the apparatuses 300 may be sent directly to the fundraising organization.

The fundraising organization distributes the apparatuses 300 to donors in a seventh step <170>. In the method described in FIG. 2, the school distributes through students the apparatuses 300 to parents, grandparents, and others. In some embodiments, the sponsors are provided with an apparatus 300 for display and money collection. Because an apparatus 300 can include multiple advertisements, sponsors would achieve the additional benefit of cross-advertising by having the apparatus 300 on display.

In an alternative seventh step, a class of sponsors agrees to match donations made at the sponsor's place of business. For example, a customer enters the establishment, such as a restaurant, for one of the class sponsors. The customer initiates the process by which donations are matched through speech, by showing a card or advertisement issued by the advertising company, or other means. The customer purchases a product or service whereby the difference between the purchase price, which may or may not include any tax due, and the amount tendered is donated by the customer and matched by the class sponsor. This provides the benefit of increased walk-in traffic for the class sponsor.

In an eighth step <180>, the donors place money in the apparatuses 300. In some embodiments, students may travel with the apparatuses seeking additional donations. Those skilled in the art will understand that the apparatus 300 may be of various sizes and a smaller size would be provided for student travel.

When the apparatuses 300 are filled, the apparatus 300 is taken to a primary sponsor in a ninth step <190>. The primary sponsor empties the filled apparatus 300 such that the apparatus 300 may be reused. For example, if a student or parent takes the apparatus 300 to the primary sponsor, such as a bank, the primary sponsor empties the apparatus 300 and returns it to the student or parent for reuse. In another example, the class sponsor takes the apparatus 300 to the primary sponsor. The primary sponsor collects all proceeds for the fundraising organization, such as a school. The ninth step <190> provides an additional benefit to the primary sponsor in the form of increased foot traffic and added potential customers. For example, a parent delivering a filled apparatus 300 to a bank must walk into the bank for delivery and thereby becomes a potential customer for the bank.

In some embodiments, steps eight <180> and nine <190> are repeated for a definite period of time, for example thirty (30) to ninety (90) days. Thus, the fund raiser is held for a certain period of time wherein donors place money in the apparatus 300, a person, such as a student or parent, takes the filled apparatus to the primary sponsor, such as a bank, the primary sponsor removes and collects money from the filled apparatuses 300, the bank returns the apparatus 300 for reuse, and donors again place money in the apparatus 300.

The primary sponsor gives all money collected to the fundraising organization in a tenth step <200>. This step allows the fundraising organization to save time and money. For example, if the primary sponsor is a financial institution, such as a bank, it will be well equipped to accept various forms of donations and convert the various donations to a convenient form readily accepted by the fundraising organization. Previously, fundraising organizations accepted various forms of donations as part of a fund raiser. Because fundraising organizations are not usually well-equipped to handle various forms of donations, they incurred great expense in converting the various donations to a convenient form. Therefore, the primary sponsor is a financial institution in the method described in FIG. 2.

In a final step eleven <210>, the fundraising organization and/or the primary sponsor report the results of the fundraiser to the advertising company. In some embodiments, this report would allow the advertising company to calculate its percentage due from the fundraiser. For example, if the agreement between the fundraising organization and the advertising company provides for the advertising company receiving a percentage of the funds received, the agreement would require that the report to the advertising company state the total proceeds from the fund raiser. In other embodiments, this data would enable the advertising company to better market its services. For example, the advertising company should the report to prospective fundraising organizations to establish credibility and provide an estimate of a proposed fundraiser.

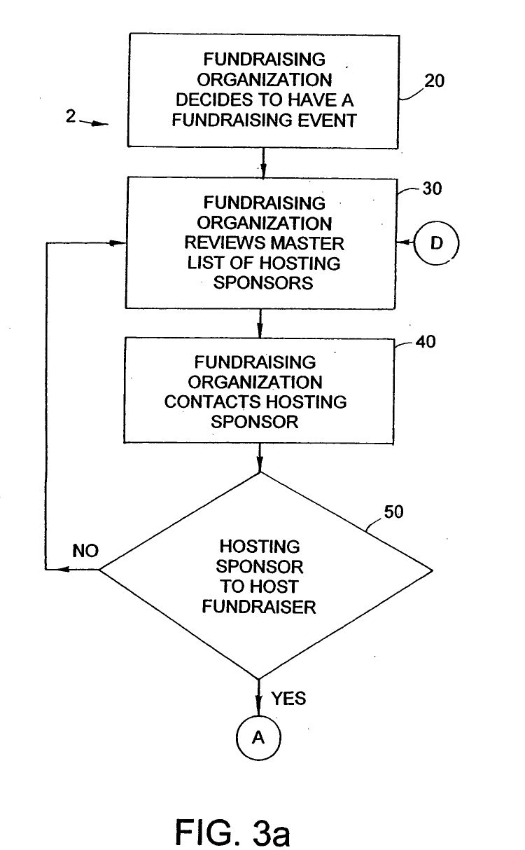

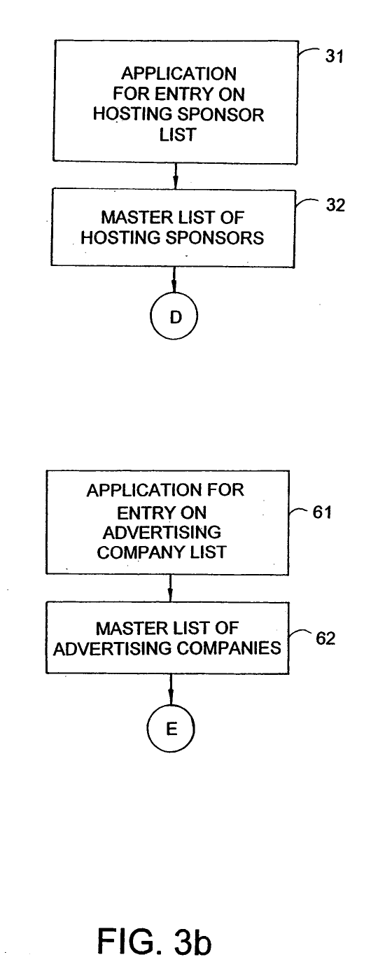

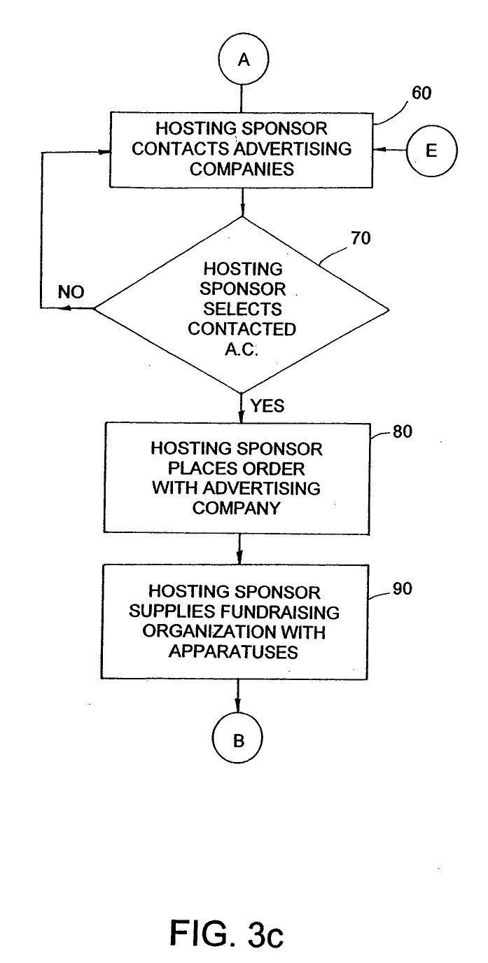

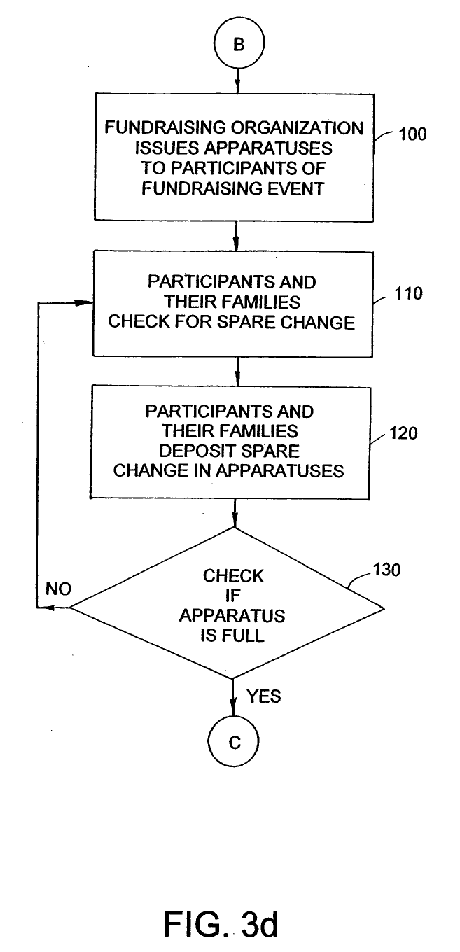

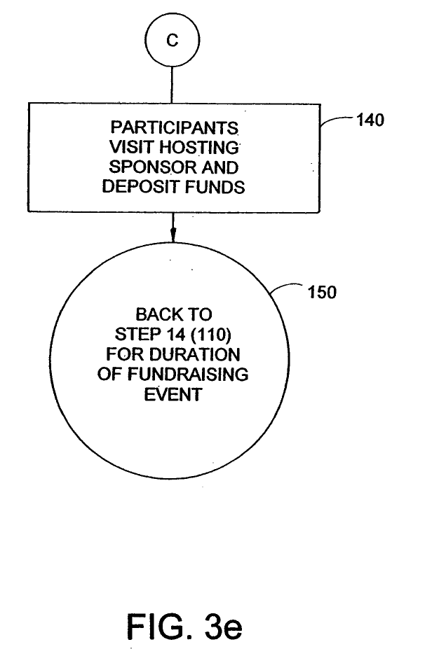

Referring now to FIGS. 3a-e, a flowchart of a business method for advertising and fundraising to collect money is illustrated and is denoted generally by reference numeral 2. In the description of the flowchart shown in FIGS. 3a-e, the functional explanation marked with numerals in angle brackets, <nnn>, will refer to the flowchart blocks bearing that number.

A fundraising organization is the entity that desires to have a fundraiser to obtain money to offset costs and expenses or to finances special events. A hosting sponsor is an entity that desires to finance materials, such as the apparatus 300, needed for a fundraising event in exchange for an advertisement of the hosting sponsor placed on the apparatus 300 that will be used during the fundraising event. An advertising supply company creates the apparatus 300 used during the fundraising event and places the advertisements of the hosting sponsor on the apparatus 300. The hosting sponsor orders and pays for the apparatus 300 and cost for advertising (i.e., printing and packaging costs).

Referring now to FIG. 3b, a first step <31> in the method is to have those who want to become a hosting sponsor apply for entry onto a master list of hosting sponsors. A second step <32> in the method is to compile a master list of hosting sponsors who desire to be listed on the master list. A third step <61> in the method is to have advertising supply companies apply for entry onto a master supplier list of advertising supply companies. A fourth step <62> in the method is to have the advertising supply company manufacture apparatuses 300 for a fundraising event and to affix the hosting sponsor's advertisement onto the apparatuses 300.

Referring now to FIG. 3a, a fifth step <20> in the method is for the fundraising organization to decide to have a fundraising event. Once the decision has been made to conduct a fundraising event, a sixth step <30> in the method is for the fundraising organization to review the master list of hosting sponsors to select its hosting sponsor of choice.

A seventh step <40> of the method is for the fundraising organization to contact its selected hosting sponsor of choice to ascertain if the hosting sponsor desires to sponsor the fundraising event. An eighth step <50> of the method is for the selected hosting sponsor to agree to sponsor or refuse sponsorship of the fundraising event. If the selected hosting sponsor refuses to sponsor the fundraising event, the fundraising organization returns to the seventh step <40> of the method.

Referring now to FIG. 3c, and if the chosen sponsor agrees to sponsor the fundraising event, a ninth step <60> of the method is for the hosting sponsor to contact the advertising supply company of its choice. The advertising supply company will be able to provide the hosting sponsor with pricing and availability for the apparatuses 300 and the advertising costs. For example, the advertising supply company may have catalogs containing various designs of the apparatuses 300 that could be used in fundraising events.

A tenth step <70> of the method is for the hosting sponsor to decide if the advertising supply company has an acceptable apparatus 300 (i.e., acceptable design, acceptable advertising costs, acceptable production costs, etc.) for the fundraising event. If the hosting sponsor is not satisfied with the advertising supply company's apparatuses 300, the hosting sponsor returns to the ninth step <60> of the method. If the hosting sponsor is satisfied with the advertising supply company, the hosting sponsor proceeds to an eleventh step <80> of the method.

The eleventh step <80> of the method is for the hosting sponsor to place an order of sufficient quantity of apparatuses 300 to supply all fundraising participants with an apparatus 300. The hosting sponsor instructs the advertising company to place advertisements on the apparatuses 300. A twelfth step <90> of the method is for the hosting sponsor to supply the fundraising organization with a sufficient number of apparatuses 300 to supply all participants of the fundraising event with an apparatus 300.

Referring now to FIG. 3d, a thirteenth step <100> of the method is for the fundraising organization to issue the apparatuses 300 to the participants of the fundraising organization. A fourteenth step <110> of the method is for the participants and their families to check for spare change each day. A fifteenth step <120> of the method is for each participant to deposit as much of their available change as they can depart with into their apparatus 300. A sixteenth step <130> of the method is for each participant to check the apparatus 300 to determine if it is full. If the apparatus 300 is not full, the participant returns to the fourteenth step. If the apparatus 300 is full, the participant proceeds to a seventeenth step.

Referring now to FIG. 3e, the seventeenth step <140> of the method is for the participant to visit the hosting sponsor's location to make a deposit of all money collected in the apparatus 300 into the fundraising organizations account. These frequent visits from participants of the fundraising event increase the number of visitors to the hosting sponsor's location. In addition, the hosting sponsor is associated with the fundraising organization and increases its presence in the community by sponsoring the fundraising event. An eighteenth step <150> of the method is for the participants of the fundraising event to return to step fourteen for the duration of the fundraising event.

The invention in its broader aspects is not limited to the specific steps or apparatus shown and described, but departures may be made therefrom without deviating from the principles of the invention and without sacrificing its chief advantages. Other aspects, objects and advantages of the present invention can be obtained from a study of the drawings and the disclosure.

What is claimed is:

1. A method of fundraising by an advertising company, the method comprising the steps of:
a. contacting a fundraising organization to propose a fundraiser;
b. contracting with the fundraising organization to perform services associated with the fundraiser;
c. contacting at least one potential sponsor to offer an advertisement placement on at least one money collection apparatus;
d. obtaining the at least one money collection apparatus with the at least one advertisement secured thereto; and
e. wherein said step of contacting the fundraising organization occurs prior to said step of contacting at least one potential sponsor.

2. The method according to claim 1, further comprising the step of distributing the at least one money collection apparatus to a plurality of donors.

3. The method according to claim 1, further comprising the step of supplying the advertising company with a list of potential sponsors.

4. The method according to claim 1, further comprising the step of returning the at least one money collection apparatus to the advertising company.

5. The method according to claim 1, further comprising the step of contracting with the at least one potential sponsor.

6. The method according to claim 1, further comprising the step of collecting advertising information from the at least one potential sponsor.

7. The method according to claim 1, further comprising the step of specifying a total number of advertisement placements per each at least one money collection apparatus.

8. The method according to claim 1, further comprising the step of printing the at least one money collection apparatus.

9. The method according to claim 1, further comprising the step of collecting donations in the at least one money collection apparatus.

10. The method according to claim 9, further comprising the step of removing donations from the at least one money collection apparatus.

11. The method according to claim 9, further comprising the step of taking the at least one money collection apparatus to a primary sponsor.

12. The method according to claim 11, wherein said step of taking the at least one money collection apparatus to the primary sponsor is performed by a member of the fundraising organization.

13. The method according to claim 11, wherein said step of taking the at least one money collection apparatus to the primary sponsor is performed by a class sponsor.

14. The method according to claim 11, further comprising the step of converting the collected donations to a convenient form of money.

15. The method according to claim 9, further comprising the step of delivering the collected donations to the fundraising organization.

16. The method according to claim 15, further comprising the step of generating a report on the collected donations.

17. The method according to claim 16, further comprising the step of reporting the results of the fundraiser.

18. The method according to claim 16, further comprising the step of calculating a fee based on the report.

19. A method of fundraising by a fundraising organization, the method comprising the steps of:
a. identifying at least one advertising supply company to manufacture at least one money collection apparatus having at least one advertisement secured thereto;
b. contacting at least one hosting sponsor to offer advertising sponsorship;
c. receiving a commitment from the at least one hosting sponsor to provide advertising sponsorship;
d. obtaining the at least one money collection apparatus with at least one advertisement advertising goods or services of the committed at least one hosting sponsor secured thereto; and
e. distributing the at least one money collection apparatus via a plurality of fundraising organization participants.

20. The method according to claim 20, further comprising the step of compiling a host list of at least one hosting sponsor.

21. The method according to claim 20, further comprising the step of compiling a supplier list of at least one advertising supply company.

22. The method according to claim 20, further comprising the step of collecting donations by way of the at least one money collection apparatus.

23. The method according of claim 22, further comprising the step of depositing the collected donations with the at least one hosting sponsor.

24. A method of fundraising by an advertising company, the method comprising the steps of:
a. contacting a fundraising organization to propose a fundraiser;
b. contracting with the fundraising organization to perform services to enable the fundraiser;
c. contacting at least one potential sponsor to offer an advertisement placement on at least one money collection apparatus;
d. obtaining the at least one money collection apparatus with at least one advertisement secured thereto;
e. distributing the at least one money collection apparatus to a plurality of donors;
f. collecting donations in the at least one money collection apparatus; and
g. taking the at least one money collection apparatus containing collected donations to a primary sponsor.
